(19) United States
(12) Patent Application Publication
(10) Pub. No.: US 2005/0004285 A1
(43) Pub. Date: Jan. 6, 2005

(54) Dimensionally-stable propylene polymer foam with improved thermal aging

(76) Inventors: Christine Delabroye, Strasbourg (FR); Lena T. Nguyen, Midland, MI (US); Jean-Francois Koenig, Strasbourg (FR); Marc Heekmann, Lampertheim (FR); William G. Stobby, Midland, MI (US); Chung P. Park, Waltham, MA (US); Ananda M. Chatterjee, Katy, TX (US)

Correspondence Address: THE DOW CHEMICAL COMPANY;INTELLECTUAL PROPERTY SECTION, P. O. BOX 1967, MIDLAND, MI, 48641-1967, US

(21) Appl. No.: 10/502,673

(22) PCT Filed: Jan. 13, 2003
(86) PCT No.: PCT/US03/00953

Related U.S. Application Data
(60) Provisional application No. 60/360,782, filed on Mar. 1, 2002.

(51) Int. Cl. C08K 5/17; C08K 5/02; C08K 3/04; C08K 5/33; C08F 2/00

(52) U.S. Cl. 524/236; 521/142; 524/495; 524/464

(57) ABSTRACT

A propylene polymer foam that contains both a bromine compound, especially an aromatic bromine compound, as a flame retardant additive and an infrared radiation blocking or attenuation compound such as carbon black or graphite and has enhanced resistance to thermal degradation over time due to incorporation of certain stabilizing additives in addition to phenolic-based antioxidants. The foam has utility in thermal insulation applications.

### CROSS REFERENCE STATEMENT

This application claims the benefit of U.S. Provisional Application No. 60/360,782, filed Mar. 1, 2002.

### BACKGROUND OF THE INVENTION

This invention relates generally to propylene polymer foams suitable for use in thermal insulation applications. It relates particularly to such foams that include both a halogenated flame retardant additive and an infrared radiation blocking additive. It relates more particularly to propylene polymer foams that have an enhanced stability against polymer degradation or decomposition at use temperatures, preferably at or above ambient temperature, the enhanced stability preferably being sufficient to meet criteria for use of articles fabricated from such foams, and applications for such foams. Foam longevity, or enhanced foam stability for extended periods of time, may be simulated by testing at elevated temperatures (e.g. 60° Centigrade (° C.) or above (up to 150° C.)). Such testing indicates that the foams should also exhibit enhanced stability against polymer decomposition or degradation at higher use temperatures (e.g. up to, but not including, the melt temperature of the polymer within the polymer composition that has the lowest melting point) for short periods of time. It relates still more particularly to such foams that also include a novel stabilizer package that provides the enhanced stability, relative to comparable foams that lack such a stabilizer package.

Synthetic polymer foams are useful, for example, as insulation in building materials, vehicles, and consumer goods. An increased demand exists for improvements in flame retardant properties of materials used in such products in order to make them slower to ignite and retard flame propagation. One approach to improving flame retardant properties of thermoplastic polymers involves using flame retardant additives such as halogenated organic compounds. However, the addition of flame retardants in foamed polymeric compositions is associated with a variety of problems such as difficulty in obtaining homogeneous blending of the thermoplastic polymer or matrix resin with the flame retardant additives, and poor foaming. There is a need for more efficient flame retardant systems for use with thermoplastic polymer compositions, preferably systems that do not detrimentally affect foam properties.

Poly(alpha-olefin) resins, such as propylene polymer resins, are particularly susceptible to chain scission due to the induction effect of the alpha-methyl side group which makes the tertiary hydrogen liable for abstraction. Reviews by T. J. Henman, “Melt Stabilization of Polypropylene”, Dev. Poly. Stab., Vol. 1 (1979), pages 39-99, and M. Iring et al, “Thermal Oxidation of Polyethylene and Polypropylene: Effects of Chemical Structure and Reaction Conditions on the Oxidation Process”, Prog. Polymer Science, Volume 15(2), pages 217-262 (1990) describe the thermal and oxidation based chain scission chemistries associated with polypropylene and other poly(alpha-olefins).

T. Schmutz, in “‘HATS’: The future of long-term thermal stabilization of polyolefins”, Petroleum and Coal, Volume 37, Number 3, pages 44-49, explores performance of hindered amine stabilizers (e.g. TINUVIN™ 622, CHIMASSORB™ 944 and CHIMASORB™ 119) as hindered amine thermal stabilizers (HATS) and hindered amine light stabilizers (HALS) when resistance to degradation induced by exposure to ultraviolet (UV) light is desired.

F. Gugumus, in “Advances in the Stabilization of Polyolefins”, Polymer Degradation and Stability Volume 24, pages 289-301 (1989), reviews polyolefin stabilization with respect to processing, long term heat aging and UV stability. Like Schmutz, Gugumus does not disclose polyolefin foam stabilization.

Fabricated articles, such as tapes and molded articles, formed from propylene polymer compositions that include a flame retardant additive are known. Fabricated articles that require enhanced longevity relative to ultraviolet (UV) light exposure typically include carbon black to improve resistance to UV light-induced degradation. Carbon black is a particularly favored additive when color is not a factor in market acceptance of the article. One such carbon black is furnace black, with a particle size less than 60 nanometers (nm) and a conventional loading in a range of from 0.5 to 2 percent by weight (wt %), based on propylene polymer weight.

Shannon K. Handegan, in “The Effect of Bis(2,4 di-t-butylphenyl_Pentaerythritol Diphosphite on Reinforced Polypropylene”, Polyolefins VIII, International Conference, (1993), pages 400-413, notes that the addition of filler materials such as talc to polypropylene generally decreases its thermal stability.

Certain flame retardant additives that contain saturated carbon-bromine bonds with hydrogen bonded to adjacent beta-carbons (such as hexabromocyclododecane (HBCD), bis(dibromopropyl) ether of tetrabromobisphenol A) and others described in U.S. Pat. No. 5,171,757 at column 5, lines 14-33, the teachings of which are incorporated herein by reference (collectively referred to as “aliphatic bromine compounds”), may yield propylene polymer foams with acceptable results in fire response tests (such as a B2 rating by Deutsche Industrienorm (DIN)) test 4102. These flame retardant additives can be unstable at propylene polymer process temperatures (e.g. 200° C. to 270° C.). This instability can result in degrading the propylene polymer and reducing its melt strength. A reduction in polymer melt strength can affect foam cell integrity during expansion, particularly when preparing flexible, low density (less than (<) 1.5 pounds per cubic foot (pcf) or 24 kilograms per cubic meter (kg/m³)) propylene polymer foams. In addition, aliphatic bromine compounds are known to be susceptible to attack by radical generating compounds called FR synergists. See e.g. J. Eichorn, J. Applied Poly. Sci., Vol 8, P.2497-524, 1964 and U.S. Pat. No. 3,420,786. The radical species generated during oxidative degradation of propylene polymers are very similar and in theory can also cause degradation of an aliphatic bromine compound.

Adding a thermal stabilizer to improve stability of propylene polymer foams that include aliphatic bromine compounds as flame retardant additives, while attractive at first glance, provides other challenges. For example, certain thermal stabilizers (e.g. HALS) can reduce the thermal stability of such flame retardant additives due to promotion of dehydrohalogenation reactions.

Some bromine-containing flame retardants provide acceptable performance in fire tests and do not degrade the propylene polymer resins even at process temperatures above 250° C. These halogenated flame retardants typically have the bromine bonded to unsaturated or aromatic carbons and are referred to as “aromatic bromine compounds”. The aromatic bromine compounds have better thermal stability than the aliphatic bromine compounds, presumably due to a lower susceptibility to dehydrohalogenation reactions.

Even though aromatic bromine compounds provide acceptable thermal stability when used as a flame retardant additive for propylene polymer resins at such process temperatures, challenges remain. Some aromatic bromine compounds are believed to interfere with creation of a propylene polymer foam. One indication of interference is an increase in cell nucleation relative to a propylene polymer foam that is identical save for the absence of an aromatic bromine compound. Cell nucleation leads, in turn, to a reduction in cell size relative to the foam that lacks the aromatic bromine compound. A reduction in cell size translates to difficulty in obtaining a large foam cross-section.

Certain aromatic bromine compounds and aliphatic bromine compounds have a structure that suggests potential adverse affects upon accelerated aging performance of propylene polymer foams. This includes structures that could be susceptible to oxidation and/or have a tendency to exude out of the polyolefin resin, typically known as “blooming”. Blooming becomes an issue for some brominated flame retardants when levels are increased to achieve favorable results in more severe “response to fire” tests. It is believed that exuding flame retardant can also transport thermal stabilizers present in an article to article surfaces, thereby reducing the stabilizer's ability to protect the polymer against degradation.

When preparing propylene polymer foams, addition of infrared radiation absorbers or blocking compounds, such as carbon black, at a loading of more than (>) 0.5 wt %, based on weight of propylene polymer, introduces further complications. The complications arise from interactions of such compounds with other foamable composition components, especially anti-oxidants and flame retardant additives. Such interactions can lead to reductions in one or more of foam cell size, flame retardant performance and thermal aging longevity, all determined relative to an identical foam save for the absence of an infrared radiation blocking compound.

It would be desirable if there were available a combination of infrared radiation absorber, flame retardant and stabilizers that promotes thermal stability during foam processing, effects desirable foaming characteristics, and yields a propylene polymer foam with satisfactory flame retardance and thermal aging longevity.

### SUMMARY OF THE INVENTION

One aspect of the present invention is a propylene polymer foam comprising: a. a polymer resin composition having a propylene moiety content of at least 50 percent by weight, based upon composition weight; b. an amount of infrared radiation blocking material sufficient to provide the foam with a thermal conductivity that is at least 0.0005 Watts per meter-kelvin less than the thermal conductivity of a propylene polymer foam comprising only a, c., d., and e.; c. at least one bromine compound, preferably an aromatic bromine compound, the bromine compound being present in an amount sufficient to provide the foam with DIN 4102 flammability rating of B2; d. a phenolic-based antioxidant; and e. at least one stabilizing additive selected from hindered amine light stabilizers, N-alkoxy amine stabilizers, N-hydroxyl amine stabilizers and thiosynergists, the stabilizing additive(s) being substantially non-reactive with the aromatic bromine compound and present in an amount sufficient to provide the foam with a resistance to thermal aging, at a temperature of 150° C. (degrees Centigrade), that is both (1) at least 25 days, preferably at least 27 days and more preferably at least 30 days, in duration and (2) 3 (three) days, preferably at least 4 days, more preferably at least 5 days and still more preferably at least 6 days, longer than the resistance to thermal aging of a foam comprising only a., b., c., and d. The foam may further comprise a phosphite compound. The foam may still further comprise a filler surface deactivator (FSD) such as an epoxy resin.

The foam has utility in thermal insulation applications such as insulation between wall studs in wood frame construction, insulation between rafters or ceiling joists, or as the insulation component within an insulated concrete wall panel or an interior cavity of a brick and concrete block wall or a poured concrete wall. The foam has further utility in other end use applications where propylene polymer foams are currently used. Skilled artisans recognize other uses for such foams.

### DESCRIPTION OF PREFERRED EMBODIMENTS

“Foam longevity” refers to a period of time or product lifetime over which a foam performs its intended function.

An “improvement in foam longevity” means an increase in elapsed time required to obtain a weight loss of more than (>) two percent (2%) at 150° C. relative to that required for a control polypropylene foam having a density within a range of from 14.5 kg/m³ to 19.5 kg/m³ (0.9-1.2 pcf). The control foam contains 0.1 wt % of a primary phenolic stabilizer (IRGANOX™ 1010), 0.1 wt % of a phosphite based stabilizer (IRGAFOS™ 168 or ULRANOX™ 626) and 7 wt % of a thermal black having a particle size of 280-300 nm and a Brunauer-Emmet-Teller (BET) surface area of 10-20 square meters per gram (m²/g) per ASTM D4820. The weight percentages are all based on foam weight.

Where ranges are stated in this Application, the ranges include both endpoints of the range unless otherwise stated.

The polymer resin composition is preferably a propylene polymer resin composition that comprises a polypropylene (PP) homopolymer, a propylene copolymer, a blend of PP homopolymer and one or more propylene copolymers or a blend of two or more propylene copolymers. Other suitable propylene polymers include (a) random and block copolymers of propylene and an olefin selected from ethylene, 1-olefins (alpha (α)-olefins) containing 4 to 10 carbon atoms (C₄₋₁₀) and C₄₋₁₀ dienes, and (b) random terpolymers of propylene and two monomers selected from ethylene and C₄₋₁₀ α-olefins. The C₄₋₁₀ α-olefins may be linear or branched, but are preferably linear. Suitable propylene polymer materials have a melt flow rate or MFR (ASTM D-1238, Condition 230° C./2.16 kilograms (kg)) of 0.01-100 grams per ten minutes (g/10 min), preferably 0.05-50 g/10 min, more preferably 0.1-20 g/10 min, and still more preferably 0.1 to 3 g/10 min. U.S. Pat. No. 5,527,573 discloses suitable propylene polymer materials at column 3, lines 27-52, the teachings of which are incorporated herein by reference.

The PP and propylene copolymer resins may, if desired, be high melt strength resins prepared by a branching method known in the art. The methods include irradiation with high energy electron beam (U.S. Pat. No. 4,916,198), coupling with an azidofunctional silane (U.S. Pat. No. 4,714,716) and reacting with a peroxide in the presence of a multi-vinyl functional monomer (EP 879,844-A1). The teachings of such references are incorporated herein by reference to the maximum extent allowed by law. Satisfactory results follow, however, from use of less expensive resins or additives.

Particularly useful propylene copolymers are those copolymers of propylene and one or more non-propylenic olefins. Propylene copolymers include random, block, and grafted copolymers of propylene and an olefin selected from the group consisting of ethylene, C₄₋₁₀ α-olefins, and C₄₋₁₀ dienes. Propylene copolymers also include random terpolymers of propylene and α-olefins selected from the group consisting of ethylene and C₄₋₈ α-olefins. In terpolymers having both ethylene and C₄₋₈ α-olefins, the ethylene content is preferably 45 wt % or less (≦), based on terpolymer weight. The C₄₋₁₀ 1-olefins include the linear and branched C₄₋₁₀ α-olefins such as, for example, 1-butene, isobutylene, 1-pentene, 3-methyl-1-butene, 1-hexene, 3,4-dimethyl-1-butene, 1-heptene, 3-methyl-1-hexene, and the like. Examples of C₄₋₁₀ dienes include 1,3-butadiene, 1,4-pentadiene, isoprene, 1,5-hexadiene, 2,3-dimethyl-1,3-hexadiene, and the like.

The polymer resin composition may further comprise one or more non-propylenic polymers. Regardless of composition, the polymer resin composition preferably comprises greater than (>) 50, more preferably >60, and still more preferably at least (≧)70 wt % of propylene monomeric units.

Suitable non-propylenic polymers include, without limitation, high, medium, low, and linear low density polyethylenes, polybutene-1, ethylene/acrylic acid copolymers, ethylene/vinyl acetate copolymers, ethylene/propylene copolymers, styrene/butadiene copolymers, ethylene/styrene copolymers, ethylene/ethyl acrylate copolymers, and ionomers.

Foams of the present invention preferably include one or more aromatic bromine (Ar—Br) compounds. The Ar—Br compounds function as flame retardant additives. Suitable Ar—Br compounds are well-known in the art and include, but are not limited to, tetrabromobisphenol-A (TBBA); decabromodiphenyl ethane; brominated trimethylphenylindane; hexabromodiphenyl ethers; octabromodiphenyl ethers; decabromodiphenyl ethers; decabromodiphenyl ethanes; 1,2-bis(tribromophenoxy)ethanes; 1,2-bis(pentabromophenoxy)ethanes; ethylene(N, N′)bis-tetrabromophthalimides; tetrabromophthalic anhydrides; a di-2-ethylhexyl ester of tetrabromophthalate (TBP); hexabromobenzenes; brominated indanes; brominated phosphate esters; brominated polystyrenes; and polymers of brominated bisphenol-A and epichlorohydrin, and mixtures thereof, or aromatic halogenated flame retardants with similar kinetics. Specific examples of suitable Ar—Br compounds include decabromodiphenyl ethane (DBDE) (e.g. SAYTEX™ 8010, commercially available from Albemarle Corporation), and brominated trimethylphenyl indane (BTPI) (e.g. FR-1808, commercially available from Dead Sea Bromine Group), brominated epoxy resins, (BER) such as DER 560 and F-2016 or F-2300, commercially available respectively from The Dow Chemical Company and Dead Sea Bromine Group, and end capped brominated epoxy resins (ECBER) (e.g. F-3014 or F-3516, both commercially available from Dead Sea Bromine Group. Ar—Br compounds are preferred over aliphatic bromine compounds because the latter tend to be unstable at processing temperatures above 200° C., particularly above 250° C. The Ar—Br compounds are present in an amount of at least 0.2 wt %, preferably at least 0.35 wt % and more preferably at least 0.8 wt %, preferably up to 12 wt % and more preferably up to 6 wt %, based on total polymer weight.

Ar—Br compounds also include compounds based on bromine substituted neopentyl groups because they lack beta hydrogens and should not be susceptible to dehydrohalogenation. Examples of the latter compounds include tribromoneopentyl alcohol (FR-513), tris(tribromoneopentyl)phosphate (FR-370), and dibromoneopentyl glycol (FR-522), all commercially available from Dead Sea Bromine Group (DSBG).

Suitable aliphatic brominated (Al—Br) flame retardant compounds include and are not limited to hexabromocyclododecane (HBCD) (e.g. CD-75P, commercially available from Great Lakes Chemical Corp.); tris(2,3-dibromopropyl)phosphate; tetrabromo-cyclooctane; pentabromochlorocyclohexane; 1,2-dibromo-4-(1,2-dibromoethyl)cyclohexane; hexabromo-2-butene; 1,1,1,3-tetrabromononane; tetrabromobisphenol A bis (2,3-dibromo-propyl ether) (e.g. PE-68, commercially available from Great Lakes Chemical Corp.); and mixtures thereof. HBCD and aliphatic halogenated flame retardants with similar kinetics are preferred.

Al—Br compounds are also commercially available in stabilized versions. An example of a stabilized HBCD is BRE5300, commercially available Great Lakes Chemical Co. Typically, an acid scavenger (e.g. hydrotalcite or Zeolite A) and/or a heat stabilizer (e.g. an organotin carboxylate) is mixed into the Al—Br compound to improve the process end-use temperature. These stabilized Al—Br compounds are considered suitable for use in propylene polymer foams of this invention.

Aliphatic chlorine compounds find less favor than their brominated counterparts for two reasons. First, the chlorine compounds must be used in larger amounts than their brominated counterparts. Second, such chlorine compounds also tend to have lower thermal stability than aliphatic bromine compounds.

Aromatic chlorine compounds can be also considered for use as flame retardant additives, but like their aliphatic chlorine counterparts, higher loading will be required as compared to aromatic bromine compounds. Some examples of aromatic chlorine compounds can be found in J. Lyons, “The Chemistry and Use of Fire retardants”, 1987, Robert E. Krieger Publishing Co., Chapter 3, Some Chemistry of Antimony, Boron, Chlorine, and Bromine, Table 3:10, p.96-7 (1987).

Foams of the present invention include one or more stabilizing additives selected from HALS, N-alkoxy amine stabilizers (NOR), hydroxyl amine stabilizers (NOH), and thiosynergists such as thioethers. Stabilizing additive choice involves weighing factors such as end use temperature and extent of exposure to ultraviolet (UV) light. HALS and NOR compounds tend to be effective at aging temperatures below 120° C. whereas sulfur-containing compounds in general and thioethers in particular have utility at aging temperatures of 100° C. or more. The stabilizing additives are present in an amount sufficient to provide foams of the present invention with a resistance to thermal aging, at a temperature of 150° C., that is both (1) at least 25 days in duration, preferably at least 27 days and more preferably at least 30 days, from beginning of testing until the foam has a weight loss of more than two percent (2%) and (2) at least 3 days longer, preferably at least 4 days longer, more preferably at least 5 days longer and still more preferably at least 6 days longer, than the resistance to thermal aging of a foam that is identical save for the absence of the stabilizing additives.

Illustrative thiosynergists or sulfur-containing compounds suitable for use in foams of the present invention include those with sulfide or sulfoxide structures as well as speculative systems such as zinc mercaptobenzthiazole, all of which are discussed by T. J. Henman in “Melt Stabilization of Polypropylene” cited above. Satisfactory results may also follow from use of a mercaptobenzimidazole compound such as 2-mercaptotolylimidazole, 2 mercaptobenzimidazole, zinc 2-mercaptotolylimidazole, zinc 2-mercaptobenzimidazole and others disclosed in U.S. Pat. No. 6,197,852, the teachings of which are incorporated herein by reference, especially those found at column 4, lines 10-31. The thiosynergist is preferably a thioether such as IRGANOX™ PS802 (dioctadecyl 3,3′-thiodipropionate, Ciba Specialty Chemicals Corp.), a high molecular weight, organic, sulfur-containing, hydroxy compound such as SEENOX™ 412S (β-laurylthiopropionate, Crompton), or a phenolic containing thioether such as IRGANOX™ 1035 (thiodiethylene bis(3,5-di-tert-butyl-4-hydroxyhydrocinnamate, Ciba Specialty Chemicals Corp.). Especially preferred amounts of thiosynergist range from 0.05 to 2 wt %, more preferably 0.1 to 0.7 wt %, based on polymer resin composition weight.

Illustrative HALS include CHIMASSORB™ 119, an oligomeric, sterically hindered amine light stabilizer compound commercially available from Ciba Specialty Chemicals, CHIMASSORB™ 944, an oligomeric, sterically hindered amine light stabilizer compound (poly{[6-[(1,1,3,3-tetramethyl butyl)imino]-1,3,5-triazine-2,4-diyl][2-(2,2,6,6-tetramethylpiperidy10imino]hexamethylene [4-(2,2,6,6-tetramethylpiperidyl)imino]}) commercially available from Ciba Specialty Chemicals, CYASORB™ UV-3529, a sterically hindered amine light stabilizer compound (1,6-hexanediamine-N,N′-bis(2,2,6,6-tetramethyl-4-piperidinyl)), polymers with morpholine-2,4,6-trichloro-1,3,5-trazine commercially available from Cytec Industries Inc., and TINUVIN™ 622, an oligomeric sterically hindered amine light stabilizer (dimethyl succinate polymer with 4hydroxy-2,2,6,6-tetramethyl-1-piperidine ethanol). Especially preferred amounts of HALS range from 0.1 to 1 wt %, more preferably 0.2 to 0.8 wt %, based on polymer resin composition weight.

An illustrative NOR compound is FLAMESTAB™ 116, a n-alkoxyamine used as a UV stabilizer and flame retardant compound (commercially available from Ciba Specialty Chemicals Corp.). An illustrative NOH compound is IRGASTAB™ FS 042, a high molecular weight hydroxylamine, specifically an oxidized bis (hydrogenated tallow akyl) amine, used as a process stabilizer (commercially available from Ciba Specialty Chemicals Corp.). Especially preferred amounts of NOR compounds range from 0.10 to 1 wt %, based on polymer resin composition weight.

Thermal insulation performance in propylene polymer foams requires use of an infrared radiation blocking compound or material such as carbon black. The infrared radiation blocking compound or material is present in an amount sufficient to provide foams of the present invention with a thermal conductivity that is at least 0.0005 Watts per meter-kelvin (W/mK) less than the thermal conductivity of a foam that is identical save for the absence of the infrared radiation blocking compound. The foam has a thermal conductivity that is desirably less than (<) 0.045 W/mK, preferably <0.040 W/mK and more preferably <0.035 W/mK as measured per ASTM D3575V at an average plate temperature of 10° C.

The infrared radiation blocking compound is desirably a carbonaceous substance such as carbon black, activated carbon black or graphite. The carbonaceous substance is preferably carbon black. Illustrative carbon blacks include thermal black, furnace black, acetylene black, lamp black and channel black. The amount of carbon black is desirably at least (≧) 0.5 wt %, based upon total polymer weight. Preferred thermal insulation performance results from carbon black levels ≧2 wt %, more preferably within a range of from 5 to 10 wt %, based on polymer resin composition weight. Carbon black levels in excess of (>) 25 wt %, while they may yield a suitable foam for some purposes, are undesirable for thermal insulation uses because of adverse effects upon antioxidants and flame retardants contained in the foam. The carbon black is desirably a low structure (low particle surface area and small number of particles per aggregate as measured by ASTM D2414) carbon black with a particle size within a range of from 10 to 500, preferably from 80 to 350 nm, and a pH within a range of from 6 to 9.5. Such carbon blacks are believed to have less surface area to interact with other compounds or additives contained in the foam than carbon blacks with a particle size below that range. Suitable carbon blacks include SEVACARB™ MTLS, a carbon black with an average particle size of 300 nm commercially available from Columbian Chemicals Company, and AROSPERSE™ 15, a carbon black with an average particle size of 280 nm, commercially available from Engineering Carbon Inc.

Graphite may be used as a partial or complete replacement for carbon black. Patent Cooperation Treaty application WO 2000/37546, the teachings of which are incorporated herein to the extent allowed by law, discloses use of graphite particles having a diameter within a range of from 1 to 200 micrometers (μm) in expanded particles made of a polypropylene polymer. German patent (DE) 19740472 discloses use of graphite particles in an amount of 0.1 to 10 wt %, based on polymer resin composition weight. Such particle sizes and amounts may be used to make foams of the present invention.

The addition of fillers like talc, calcium carbonate, and carbon black to polyolefin compositions has been shown to have potential adverse effects upon long term thermal and light stability of the compositions. A primary hypothesis for such adverse effects centers on a probable reduction in stabilizer availability due to absorption of the stabilizer(s) onto filler surfaces. Pena, et.al. propose, in “Factors Influencing the Absorbtion of Stabilizers Onto Carbon Black: Microcalorimetry Studies”, J. Vinyl & Add. Tech., Vol. 6(2), June 2000, p.62-68, that for carbon black, surface carbonyl functional groups are present that “can interact physically and chemically . . . with additives such as plasticizers and stabilizers.” One may at least partially overcome the loss of stabilizer availability by increasing the level of stabilizers present in a polymer composition. The increased level, however, carries with it unwanted side effects such as blooming of the additive to surfaces of a product formed from the composition, plasticization of the polymer resin(s) used in the composition and reduction of polymer resin melt strength. The latter two effects can significantly and adversely affect one's ability to produce a stable low density polypropylene polymer foam.

A means of counteracting potential adverse affects inherent in use of fillers involves use of a compound known as a “filler surface deactivator” or “FSD” that sacrificially absorbs onto filler surfaces. Fay and Klingert demonstrate, in “Improving the Physical Properties of Filled Polyolefins”, Polyolefins IX Conf. Proceeding, February 1995, p.181-92, the ability of an epoxy resin (ARALDITE™ GT 7072 (trademark of Vantico)) to act as a FSD. Another suitable epoxy compound is DER 330 (The Dow Chemical Company).

Propylene polymer foams of the present invention desirably include an amount of a FSD sufficient to offset potential adverse effects of the infrared radiation blocking material incorporated into the foam. The amount is preferably within a range of from 0.2 wt % to 2 wt %, preferably from 0.5 wt % to 1 wt %, based on polymer resin composition weight. The FSD may be added to a foamable formulation a) directly, b) as part of a pre-compounded concentrate such as a carbon black concentrate, or c) as a surface treatment on the infrared radiation blocking material or any other filler that is part of foamable formulations that yield propylene polymer foams of the present invention.

Foams of the present invention include a phenolic-based antioxidant such as IRGANOX™ 1010, a primary phenolic antioxidant (pentaerythritol tetrakis (3-(3,5-di-tert-butyl-4-hydroxyphenyl)propionate) used for processing and long term thermal stabilization (Ciba Specialty Chemicals), IRGANOX™ 1035, a primary phenolic antioxidant and heat stabilizer compound (thiodiethylene bis[3-(3,5-di-tert-butyl-4-hydroxyphenyl)propionate, Ciba Specialty Chemicals), and IRGANOX™ 1024, a primary phenolic metal deactivator and antioxidant compound (2′,3-bis-[[3-[,5-di-tert-butyl-4-hydroxyphenyl]propionyl]]-propionohydrazide, commercially available from Ciba Specialty Chemicals). The phenolic-based antioxidant is desirably present in an amount within a range of from greater than (>) 0 to 1, preferably >0 to 0.8 wt %, based on polymer resin composition weight. Amounts in excess of 1 wt %, while possible, provide no increase in foam longevity. Eliminating the phenolic-based antioxidant makes achieving foam longevity targets more difficult.

Foams of the present invention may also include a phosphite compound such as ULTRANOX™ 626, an organophosphite antioxidant (bis (2,4-di-tert-butylphenyl)-pentaerythritol diphosphite, GE Specialty Chemicals), and IRGAFOS™ 168, a hydrolytically stable phosphite processing stabilizer (tris(2,4-di-tert-butylphenyl)phosphite, Ciba Specialty Chemicals). The phosphite compound is desirably present in an amount within a range of from >0 to 0.2 wt %, based on polymer resin composition weight. The phosphite compound functions as a process stabilizer. In the absence of a phosphite compound, propylene polymer foams tend to degrade during extrusion processing at temperatures >200° C. Amounts in excess of 0.2 wt %, while possible, offer no further enhancement of foam longevity at elevated temperatures.

Foams of the present invention may include a nucleating compound such as calcium stearate, talc, or blends of sodium bicarbonate and citric acid. If used, the nucleating compound is preferably present in an amount within a range of 0.05-1.0 wt %, based on polymer resin composition weight. The nucleating compound helps control cell size. Cell size control may, in turn, be a factor in insulation performance of such a foam.

Foams of the present invention have a density within a range of 0.5 to 12 pounds per cubic foot (pcf) (8 to 192 kg/m³). The range is preferably from 0.5 to 2 pcf (10 to 32 kg/m³), more preferably from 0.8 to 1.5 pcf (13 to 24 kg/m³).

Thermoplastic foams may be prepared by techniques and procedures well known to one of ordinary skill in the art and include batch processes as well as extrusion processes, with extrusion processes being preferred. The foams may also be formed into non-crosslinked foam beads by an extrusion process or a batch process. Such foam beads are suitable for molding into articles. By way of example, WO 2000/15697 describes some of such techniques and processes at page 8, line 20 through page 12, line 32. The teachings of WO 2000/15697 are incorporated herein to the extent allowed by law.

In a conventional extrusion foaming process, one converts polymer constituents into a polymer melt and incorporates a blowing agent and, if desired, other additives such as a nucleator, into the polymer melt to form a foamable gel. One then extrudes the foamable gel through a die and into a zone of reduced or lower pressure that promotes foaming to form a desired product. The reduced pressure is lower than that under which the foamable gel is maintained prior to extrusion through the die. The lower pressure may be superatmospheric or subatmospheric (vacuum), but is preferably at an atmospheric level.

Preparation of suitable coalesced foam strand materials desirably uses conventional extrusion procedures and apparatus such as those detailed in U.S. Pat. No. 3,573,152, and U.S. Pat. No. 4,824,720. The teachings of these patents are incorporated herein in their entirety.

In making coalesced foam strand products of the present invention, one passes the foamable gel through a multi-orifice die into a zone of lower pressure that favors foaming. The orifices are arranged so that contact between adjacent streams of the molten extrudate occurs during the foaming process and the contacting surfaces adhere to one another with sufficient adhesion to result in a unitary foam structure. The streams of molten extrudate exiting the die take the form of strands or profiles, which desirably foam, coalesce, and adhere to one another to form a unitary structure. Desirably, the coalesced individual strands or profiles stay adhered to one another in a unitary structure to prevent strand delamination under stresses encountered in preparing, shaping, and using the foam.

Before extruding foamable gel through a die, one typically cools the foamable gel from a temperature that promotes melt mixing to a lower, optimum foaming temperature. The gel may be cooled in the extruder or other mixing device or in separate coolers. The optimum foaming temperature typically exceeds each polymer constituent's glass transition temperature (T_{g}), or for those having sufficient crystallinity to have a melt temperature (Tₘ), near the Tₘ. “Near” means at, above, or below and largely depends upon where stable foam exists. The temperature desirably falls within a range of from 30° C. above the Tₘ to 30° C. below the Tₘ. For foams of the present invention, an optimum foaming temperature is a temperature within said range at which the foam does not collapse.

The blowing agent may be incorporated or mixed into the polymer melt by any means known in the art such as with an extruder, mixer, or blender. The blowing agent is mixed with the polymer melt at an elevated pressure sufficient to prevent substantial expansion of the melt polymer material and to generally disperse the blowing agent homogeneously therein. Optionally, a nucleator may be blended in the polymer melt or dry blended with the polymer material prior to plasticizing or melting.

Any conventional blowing agent may be used to prepare the foam products of the present invention. U.S. Pat. No. 5,348,795 discloses a number of suitable blowing agents at column 3, lines 15-61, the teachings of which are incorporated herein by reference. U.S. Pat. No. 5,527,573 also discloses a number of suitable blowing agents at column 4, line 66 through column 5, line 20, the teachings of which are incorporated herein by reference. Preferred blowing agents include aliphatic hydrocarbons having 1-9 carbon atoms, especially propane, n-butane, isobutane and isopentane, more preferably isobutane, isopentane or a mixture of isobutane and isopentane. Mixtures of isobutane and isopentane desirably have an isopentane content of no more than about 50 wt %, based on mixture weight. Carbon dioxide (CO₂), including liquid CO₂, may be used as a sole blowing agent if desired, but admixtures of CO2 and one or more hydrocarbons work equally well, if not better.

Foams of the present invention may also be made using an accumulating extrusion process and apparatus such as that shown in U.S. Pat. No. 4,323,528 and U.S. Pat. No. 5,817,705, the teachings of which are incorporated herein by reference. This apparatus, commonly known as an “extruder-accumulator system” allows one to operate a process on an intermittent, rather than a continuous, basis. The apparatus includes a holding zone or accumulator where foamable gel remains under conditions that preclude foaming. The holding zone is equipped with an outlet die that opens into a zone of lower pressure, such as the atmosphere. The die has an orifice that may be open or closed, preferably by way of a gate that is external to the holding zone. Operation of the gate does not affect the foamable composition other than to allow it to flow through the die. Opening the gate and substantially concurrently applying mechanical pressure on the gel by a mechanism (e.g. a mechanical ram) forces the gel through the die into the zone of lower pressure. The mechanical pressure is sufficient to force foamable gel through the die at a rate fast enough to preclude significant foaming within the die yet slow enough to minimize and preferably eliminate generation of irregularities in foam cross-sectional area or shape. As such, other than operating intermittently, the process and its resulting products closely resemble those made in a continuous extrusion process.

As noted above, foams of the present invention may be used as an insulation component within an insulated concrete wall panel or within an interior cavity of a brick and concrete block wall or a poured concrete wall. It is believed that by incorporating component e., a stabilizing additive selected from a hindered amine light stabilizer (HALS), a N-alkoxy amine stabilizer or a N-hydroxylamine stabilizer, into the foam, one is able to overcome adverse affects of uncured concrete or mortar upon unstabilized propylene polymer foam or propylene polymer foam stabilized only with a phenolic antioxidant. In the absence of the appropriate stabilizer in a propylene polymer foam, uncured concrete or mortar promotes an oxidation reaction that leads to a breakdown in the propylene polymer. Uncured concrete, which has a basic pH level, is believed to effectively neutralize at least a portion of any phenolic antioxidant present in the foam, an action that reduces effectiveness of the phenolic antioxidant and allows the oxidation reaction to proceed unchecked. The oxidation reaction leads to a reduction in polymer foam longevity over that measured when the same propylene polymer foam is evaluated after no contact with uncured concrete or mortar. When one of the aforementioned stabilizing additives is present, no such reduction in propylene polymer foam longevity occurs. It is further believed that the stabilizing additives resist neutralization by the uncured concrete or mortar and retain their ability to stabilize the propylene polymer against the oxidation reaction.

The following examples illustrate, but do not in any way limit, the present invention. Arabic numerals represent examples (Ex) of the invention and letters of the alphabet designate comparative examples (Comp Ex). All parts and percentages are by weight unless otherwise stated. In addition, all amounts shown in the tables are based on weight of polymer contained in the respective compositions unless otherwise stated.

Table 1 below lists certain materials used in the examples together with a shorthand designation for each material listed therein.

TABLE 1
ADDITIVES

| Additive | |
|---|---|
| Designation | Additive Description |
| PPA1 | Primary Phenolic Antioxidant, IRGANOX ™ 1010, Ciba Specialty Chemicals |
| PPA2 | Primary Phenolic Antioxidant, IRGANOX ™ MD1024, Ciba Specialty Chemicals |
| PS1 | Phosphite Stabilizer, ULTRANOX ™ 815, GE Chemicals |
| TE1 | Thioether, IRGANOX ™ PS802, (dialkyl ester of thiodipropionic acid), Ciba Specialty |
| | Chemicals |
| HALS1 | Hindered Amine Light Stabilizer, CHIMASSORB ™ 119, Ciba Specialty Chemicals |
| HALS2 | Hindered Amine Light Stabilizer, TINUVIN ™ 622, Ciba Specialty Chemicals |
| NOR1 | NOR, FLAMESTAB ™ 116, Ciba Specialty Chemicals |
| NOR2 | N-hydroxylamine NOR in HALS, IRGASTAB ™ FS210, Ciba Specialty Chemicals |
| FR1 | Brominated Aromatic Flame Retardant, SAYTEX ™ 8010, Albemarle Corporation |
| FR2 | Brominated Aliphatic Flame Retardant, HBCD, BRE5300, Great Lakes Chemical Corporation |
| FR3 | Brominated Aromatic Flame Retardant, PYRONIL ™ 45, Lauryl Industries |
| FR4 | Brominated Aromatic Flame Retardant, FF 680, Great Lakes Chemical Corporation |
| FR5 | Brominated Aliphatic Flame Retardant, PE-68, Great Lakes Chemical Corporation |
| FR6 | Brominated Aromatic Flame Retardant, FR-1808, Dead Sea Bromine Group |
| FR7 | Brominated Aromatic Flame Retardant, FR-370, Dead Sea Bromine Group |
| FR8 | Brominated Aromatic Flame Retardant, DER 560, The Dow Chemical Company |
| FR9 | Brominated Aromatic Flame Retardant, BC58 Great Lakes Chemical Corporation |
| FR10 | Brominated Aromatic Flame Retardant, F3014, Dead Sea Bromine Group |
| CB1 | Carbon Black, AROSPERSE ™ 15, 280 nm average particle size, Engineering Carbon Inc. |
| CB2 | Carbon Black, SEVACARB ™, 300 nm average particle size, Columbian Chemicals Company |
| CB3 | Furnace black, Cabot Corporation, PLASBAK ™ 3037 20% compound 18 nm particle size |
| CB4 | Graphite FP 165 m, 22 micrometers Graphite Sales Inc. |
| FSD1 | Bisphenol A Epoxy resin, ARALDITE ™ GT 7072, Equivalent weight = 600-700 (g/eq), |
| | Vantico |
| FSD2 | Bisphenol A Epoxy resin, DER 330, Equivalent weight = 176-185 (g/eq), The Dow Chemical |
| | Company |

TABLE 2
Polymers

| Polymer | |
|---|---|
| Designation | Polymer description/source |
| PP1 | PP homopolymer (0.25 g/10 min MFR (230° C., 2.16 kg weight)), |
| | available from Basell Polyolefins as YD 50 g |
| PP2 | PP homopolymer (0.30 g/10 min MFR (230° C., 2.16 kg weight)), |
| | available from Basell Polyolefins as PRO-FAX ™ 6823 |
| PP3 | High melt strength PP homopolymer (3 g/10 min MFR (230° C., 2.16 kg |
| | weight)), available from Basell Polyolefins as PRO-FAX ™ PF814 |
| PP4 | PP impact copolymer (0.4 g/10 min MFR (230° C., 2.16 kg weight)), |
| | available from The Dow Chemical Company as INSPIRE ™ 112 |
| PP5 | PP homopolymer (0.7 g/10 min MFR (230° C., 2.16 kg weight)), |
| | available from Union Carbide as 5D45 |
| PP6 | PP homopolymer (2.0 g/10 min MFR (230° C., 2.16 kg weight)), |
| | available from The Dow Chemical Company as H300 |
| PP7 | PP homopolymer (1.0 g/10 min MFR (190° C., 5 kg weight)), available |
| | from Basell Polyoloflns as PLZ937 |
| PE1 | Low density polyethylene (1.8 g/10 min MFR (190° C., 2.16 kg |
| | weight)), available from The Dow Chemical Company as PE620I |
| PE2 | Low density polyethylene (1.8 g/10 min MFR (190° C., 2.16 kg |
| | weight)), available from The Dow Chemical Company as PE400R |
| Blend 1 | 80/20 (w/w) blend of PP-2 and PP-3 |
| Blend 2 | 72/28 (w/w) blend of PP-1 and PP-6 |
| Blend 3 | 93/7 (w/w) blend of PP-1 and PP-7 |
| Blend 4 | 80/20 (w/w) blend of PP-1 and PP-6 |
| Blend 5 | 50/50 (w/w) blend of PP-1 and PP-5 |
| Blend 6 | 50/50 (w/w) blend of PP-5 and DH109, PP homopolymer (0.25 g/10 min |
| | MFR (230° C., 2.16 kg weight)), available from The Dow Chemical |
| | Company |

Sample Preparation Process #1

Use a 1.57 inch (in,) (40 mm) co-rotating, twin screw-type extruder that has two additional sequential zones for mixing and cooling after typical sequential zones for feeding, melting, and metering to prepare propylene polymer foams. Provide an opening for blowing agent injection between the metering and mixing zones. After the cooling zone, attach a strand die block having defined therein 35 circular apertures (arranged in an array of 5 rows with 7 apertures per row). Each aperture has a diameter of 1.02 mm (0.04 inch). The apertures are spaced apart from one another in an equilateral triangular pattern with a distance between apertures of 4.06 mm (0.16 inch). While this example uses circular apertures, skilled artisans understand that other aperture shapes may be used if desired.

Feed blend-2 (Table 2 above) resin pellets into the extruder at a rate of 18 kg per hour (kg/hr) (40 pounds per hour (lb/hr)) together with the following additives: a primary phenolic antioxidant, a phosphite stabilizer, a thioether, a HALS, a flame retardant, carbon black and a nucleator. Table 1 above describes the additives. Table 3 below shows the amount and type of additives together with foam longevity test results. Maintain the extruder at the following set point temperatures: feeding zone=150° C.; melting zone=165-175° C., metering zone=200-220° C., and mixing zone=185-200° C. Inject isobutane blowing agent into the mixing zone at a uniform rate of 18 parts by weight per hundred parts by weight of polymer (pph).

Reduce the cooling zone temperature and die block temperature to 155-160° C. Adjust aperture diameters within a strand die block to provide a stable coalesced foam strand structure free from prefoaming. The structure, while stable, retains a soft core.

Sample Preparation Process #2

Replicate process #1, but with some apparatus and process changes. Substitute a 2 in (51 mm) screw type extruder for the 40 mm extruder of process #1, thereby allowing an increase in resin feed rate to 45-60 kg/hr (99-132 lb/hr). Use the following extruder set point temperatures: feeding zone=160° C., melting zone=190° C., metering zone=220° C., and mixing zone=220 to 245° C. Feed the blowing agent at a rate of 17 to 25 pph, rather than 18 pph. Change the strand die block to one with an increased array size of 6 to 8 rows with 11 to 22 apertures per row The array apertures have a diameter of 0.80 or 1.15 mm with a respective aperture spacing of 3.6 mm or 6.3 mm. The cooling zone and die block temperature can range from 145-165° C. depending on formulation.

Foam Testing

Conduct foam longevity testing by using a modified version of ASTM Test E632-82 and EN ISO 4577. Testing requires use of a circulating air oven equipped with an adjustable air intake and an adjustable exhaust as well as a temperature control system that provides control to the nearest 1° C. over an operating range that extends up to 200° C. Maintain air velocity within a range of from 2.45 to 4.9 feet per second (ft/sec) (0.75 to 1.5 meters per second (m/s)). Skilled artisans recognize that variations in air flow dynamics or oven environment may generate different results. Use an ionizing air gun to clean surfaces and dissipate static. Use a bandsaw to cut and a Hobart meat slicer to smooth edges of a minimum of six (6) test specimens measuring 5 centimeters (cm) by 2.5 cm by 2.5 cm (2 inch (in) by 1 in by 1 in) from each foam to be tested.

Condition the test specimens by exposing them to a temperature of 70° C. for a period of twenty four (24) hours to ensure that they are substantially free of blowing agent, then place the samples on trays lined with polyethylene terephthalate film such that the samples are at least 2.5 cm (1 in) apart and at least 5 cm (2 in) from oven walls. Heat the oven to a temperature of 150° C., as verified by a thermocouple, and begin testing.

On an as needed basis, remove trays from the oven, allow the trays and their contents to stabilize to room temperature conditions over a period of about 20 minutes, and evaluate the test specimens for evidence of oxidation. Determine oxidation of test specimens by visually inspecting test specimens for surface deterioration, discoloration or dimensional deformation. Clean specimen surfaces using an ionizing air gun (SIMCO Top Gun at an air pressure of 85 pounds per square inch (psi) or 0.025 kilograms per square meter (kg/m²) to dissipate static and remove any severely degraded propylene polymer foam material. Place each specimen on an analytical balance (Mettler Model AT261) and measure its weight. Place the, specimens back on the trays and return them to the oven, rotating tray and specimen location within the oven. Determine foam sample density according to ASTM D3575-93, Suffix W, Method A (determine foam volume by linear measurement of a specimen (a 10 centimeter (cm) cross-section that is cut from a foam), weigh the specimen and calculate apparent density (weight per unit volume) and foam cell size according to ASTM D3576.

A foam test sample is deemed to have failed longevity testing when the sample loses at least 2% of its original weight. Calculate the number of days that lapse between when the foam test sample is originally weighed (before longevity testing) and when it fails and record this number as sample longevity test time.

Modified Foam Testing for Foams Placed in Contact With Uncured Concrete

Add enough water to a fast-setting concrete mix (QUIKRETE®, commercially available from Quikrete Companies) until the concrete is properly consolidated. Using a trowel, apply about ½ inch (1.3 centimeter (cm)) of moist concrete on one side of a foam sample prepared either Sample Preparation Process #1 or Sample Preparation Process #2. Allow the resulting foam/concrete sample(s) to cure at room temperature (nominally 25° C.) overnight (nominally fourteen hours) before subjecting the sample(s) to oven aging tests as described above. The foam is determined to fail when severe degradation is observed on the foam samples. The effect of concrete on longevity is determined by comparing the longevity of the concrete side to the non-concrete side.

### COMP EX A TO H

Use Process #1 for Comp Ex A-C and Process #2 for Comp Ex D-H to prepare test samples and subject the samples to testing as described above. Comp Ex A-H all contain 0.8 wt % PPA1 and 0.2 wt % PS1. Table 3 below summarizes test results and additional sample composition information.

TABLE 3

| | | | | | | Mixer | | | |
|---|---|---|---|---|---|---|---|---|---|
| | | | | | | Gel | Cell | | Longevity, |
| | | PE, | TE1 | CB1 | CB2 | Temp. | Size, | Density | (Days |
| ID | PP Type | wt % | wt % | wt % | wt % | (° C.) | (mm) | (kg/m³) | @150° C.) |
| Comp Ex A | Blend 1 | 10 | 0 | 5 | 0 | 205 | 0.8 | 16.5 | 37 |
| Comp Ex B | Blend 1 | 10 | 0 | 0 | 5 | 193 | 0.36 | 16.7 | 25 |
| Comp Ex C | Blend 1 | 10 | 0.6 | 5 | 0 | 204 | 0.79 | 16.3 | 40 |
| Comp Ex D | Blend 2 | 15 | 0 | 5 | 0 | 234 | 0.9 | 13.9 | 18 |
| Comp Ex E | Blend 3 | 10 | 0.6 | 0 | 5 | 244 | 1.2 | 15.8 | 31 |
| Comp Ex F | PP1 | 15 | 0 | 0 | 5 | 240 | 1.3 | 15.7 | 23 |
| Comp Ex G | PP1 | 15 | 0.6 | 0 | 5 | 240 | 1.1 | 13.8 | 27 |
| Comp Ex H | PP1 | 15 | 1.0 | 0 | 5 | 240 | 1.2 | 16.1 | 28 |

The data in Table 3 show the effect of carbon black, thiosynergist, and process temperature on foam longevity. Comp Ex D and F also illustrate varying effects upon longevity based on type of carbon black. Comp Ex C and D shows that an increase in process temperature also adversely affects foam longevity. A comparison of Comp Ex A with Comp Ex C and Comp Ex F with Comp Ex G demonstrate that including a thiosynergist increases foam longevity. Comp Ex B is believed to be a bad data point as its cell size indicates the potential presence of contaminants that might also affect longevity testing.

### COMP EX I

Replicate Comp Ex C, but omit carbon black and increase the process temperature from 204° C. to 215° C., to produce Comp Ex I. Comp Ex I has a smaller cell size (0.4 mm versus 0.79 mm), a lower density (14.6 kg/m3 versus 16.2 kg/m3), but a greater longevity (53 days versus 40 days). A comparison of Comp Ex I with Comp Ex C illustrates how carbon black adversely affects foam longevity even in the presence of a phenolic antioxidant and a thioether. Similar results follow with changes in amounts of PE relative to PP (e.g. an increase in PE amount to 30 wt %, based on combined weight of PE and PP).

### EX 1-6 AND COMP EX J-L

Use Process #1 to prepare Ex 1 and Comp Ex J and K and Process #2 to prepare Ex 2-6 and Comp Ex L. Ex 1-6 and Comp Ex J-L all contain 0.8 wt % PPA1 and 0.2 wt % PS1. Ex 5 and 6 also contain 0.1 wt % PPA2. Table 4 below summarizes test results and additional sample composition information.

TABLE 4

| | | | | | | | | Mixer | | | |
|---|---|---|---|---|---|---|---|---|---|---|---|
| | | | | | | | | Gel | Cell | | Longevity, |
| | | FR1, | CB | CB | PE1 | PE2 | TE1 | Temp | Size | Density | (Days |
| ID | PP Type | (wt %) | Type | (wt %) | (wt %) | (wt %) | (wt %) | (° C.) | (mm) | (kg/m³) | @150C.) |
| Comp Ex J | Blend 1 | 0.35 | CB2 | 5 | 10 | 0 | 0 | 194 | 0.5 | 15.7 | 38 |
| Comp Ex K | Blend 1 | 0.35 | CB1 | 5 | 10 | 0 | 0 | 203 | 1.04 | 16.9 | 38 |
| Ex 1 | Blend 1 | 0.35 | CB1 | 5 | 10 | 0 | 0.6 | 201 | 0.54 | 16.0 | 43 |
| Comp Ex L | PP1 | 0.35 | CB1 | 5 | 0 | 15 | 0 | 240 | 1.0 | 17.0 | 23 |
| Ex 2 | PP7 | 0.35 | CB2 | 7 | 0 | 15 | 0.6 | 243 | 1.0 | 14.7 | 30 |
| Ex 3 | PP7 | 0.5 | CB2 | 7 | 0 | 15 | 0.6 | 242 | 0.99 | 13.6 | 28 |
| Ex 4 | PP7 | 0.7 | CB2 | 7 | 0 | 15 | 0.6 | 242 | 1.0 | 15.2 | 28 |
| Ex 5 | Blend 3 | 1.5 | CB1 | 5 | 0 | 10 | 0.6 | 232 | 0.65 | 17.1 | 33 |
| Ex 6 | Blend 3 | 2.5 | CB1 | 5 | 0 | 10 | 0.6 | 232 | <0.2 | 21.5 | 33 |

The data presented in Table 4 show that inclusion of a thioester enables one to add an aromatic bromine flame retardant and still have acceptable foam longevity. Ex 5 and 6 show that increasing levels of flame retardant promote nucleation resulting in foams with smaller cells. Ex 5 and 6 also contain a metal deactivator (PPA2), giving slightly higher longevity values. The small cell size of Ex 6 is believed to be due to a nucleating effect from the large amount of FR1.

### EX 7-10 AND COMP EX M-N

Use Process #2 to prepare Ex 7-10 and Comp Ex M-N. Ex 7-10 and Comp Ex M-N all contain 0.8 wt % PPA1. Ex 7-8 and Comp Ex M use FR2 and Ex 9-10 and Comp Ex N use FR5. Both FR2 and FR5 are aliphatic bromine compounds. Table 5 below summarizes test results and additional composition and process information.

TABLE 5

| | | | | | | | Mixer | | | |
|---|---|---|---|---|---|---|---|---|---|---|
| | | | | | | | Gel | Cell | | Longevity |
| | PP | FR | TE1 | CB1 | CB2 | PS1 | Temp | Size, | Density | (Days |
| ID | Type | (wt %) | (wt %) | (wt %) | (wt %) | (wt %) | (° C.) | (mm) | (kg/m³) | @150° C.) |
| Comp Ex M | Blend 4 | 0.5 | 0 | 5 | 0 | 0 | 217 | .88 | 13.2 | 6 |
| Ex 7 | Blend 3 | 1.5 | 0.6 | 0 | 7 | 0.2 | 221 | 0.7 | 14.5 | 33 |
| Ex 8 | Blend 3 | 3 | 0.6 | 0 | 7 | 0.2 | 220 | 0.8 | 18.1 | 33 |
| Comp Ex N | PP1 | 0.5 | 0 | 5 | 0 | 0 | 217 | 0.88 | 14.1 | 10 |
| Ex 9 | Blend 3 | 1.5 | 0.6 | 0 | 7 | 0.2 | 221 | 0.50 | 14.5 | 37 |
| Ex 10 | Blend 3 | 3.0 | 0.6 | 0 | 7 | 0.2 | 221 | 0.40 | 15.0 | 37 |

The data presented in Table 5 show that use of an aliphatic bromine compound in conjunction with a thiosynergist produces acceptable foam longevity.

### EX 11-23 AND COMP EX O-S

Use Process #2 to prepare Ex 11-20 and Comp Ex O-S. Ex 11-20 and Comp Ex O-S all contain 0.2 wt % PS1. Bromine compound types and amounts are as follows: Ex 11-12=0.5 wt % FR4; Ex 13=0.5 wt % FR8; Ex 14-16=0.8 wt % FR3; Comp Ex O=4 wt % FR3; Comp Ex P=6 wt % FR 3; Ex 17=1.25 wt % FR6; Ex 18=2.5 wt % FR6; Ex 19=5.0 wt % FR6; Comp Ex Q=1.5 wt % FR1 and 1.5 wt % FR4; Comp Ex R=1.5 wt % FR1 and 2.5 wt % FR4; Ex 20=1.5 wt % FR7; Ex 21=3.0 wt % FR7; Comp Ex S=0.4 wt % FR9; Ex 22=1.0 wt % FR10; and Ex 23=2.5 wt % FR10. Table 6 below contains additional composition and process information as well as test results.

TABLE 6

| | | | | | | | Mixer | | | |
|---|---|---|---|---|---|---|---|---|---|---|
| | | | | | | | Gel | Cell | | Longevity |
| | | PE2 | TE1 | PPA1 | CB2 | CB1 | Temp | Size, | Density | (Days |
| ID | PP Type | (wt %) | (wt %) | (wt %) | (wt %) | (wt %) | (° C.) | (mm) | (kg/m³) | @150° C.) |
| Ex 11 | PP1 | 15 | 0.6 | 0.4 | 7 | 0 | 239 | 1.31 | 14.6 | 27 |
| Ex 12 | PP5 | 10 | 0.6 | 0.8 | 7 | 0 | 242 | 0.65 | 14.4 | 28 |
| Ex 13 | Blend 3 | 10 | 0.6 | 0.8 | 7 | 0 | 242 | 1.20 | 14.9 | 37 |
| Ex 14 | PP1 | 15 | 0.6 | 0.4 | 7 | 0 | 239 | 1.39 | 13.5 | 27 |
| Ex 15 | PP5 | 10 | 0.6 | 0.8 | 7 | 0 | 242 | 1.30 | 15.6 | 28 |
| Ex 16 | PP5 | 10 | 0.6 | 0.8 | 7 | 0 | 243 | 1.39 | 17.4 | 30 |
| Comp Ex O | Blend 3 | 10 | 0.6 | 0.8 | 5 | 0 | 244 | 1.40 | 15.4 | 9 |
| Comp Ex P | Blend 3 | 10 | 0.6 | 0.8 | 5 | 0 | 244 | 1.40 | 15.7 | 12 |
| Ex 17 | Blend 3 | 10 | 0.6 | 0.8 | 5 | 0 | 246 | 1.50 | 14.8 | 31 |
| Ex 18 | Blend 3 | 10 | 0.6 | 0.8 | 5 | 0 | 246 | 1.50 | 14.4 | 31 |
| Ex 19 | Blend 5 | 12 | 0.6 | 0.8 | 5 | 0 | 215 | 1.29 | 13.6 | 28 |
| Comp Ex Q | Blend 3 | 10 | 0.6 | 0.8 | 0 | 5 | 232 | 1.20 | 15.8 | 24 |
| Comp Ex R | Blend 3 | 10 | 0.6 | 0.8 | 0 | 5 | 241 | 1.20 | 15.6 | 17 |
| Ex 20 | Blend 3 | 10 | 0.6 | 0.8 | 5 | 0 | 220 | 1.40 | 14.4 | 37 |
| Ex 21 | Blend 3 | 10 | 0.6 | 0.8 | 5 | 0 | 239 | 1.50 | 14.6 | 28 |
| Comp Ex S | PP1 | 15 | 0 | 0.8 | 5 | 0 | 243 | <0.4 | 26.0 | nd |
| Ex 22 | PP1 | 13 | 0.6 | 0.8 | 8 | 0 | 226 | nd | 14.2 | 38 |
| Ex 23 | PP1 | 13 | 0.6 | 0.8 | 8 | 0 | 226 | nd | 14.4 | 38 |

“nd” means not determined

The data presented in Table 6 show that Ex 11-23 yield acceptable results in terms of foam longevity. Ex 11-23 and Comp Ex O-S also achieve a B2 flammability rating. Ex 11, 13-23 combine excellent longevity values with large cell size. Comp Ex O-R show that increasing amounts of flame retardant additives can adversely affect foam longevity. Comp Ex S shows that flame retardant additive can adversely effect the foam cell size.

### EX 24-25 AND COMP EX T

Use Process #2, PP-1 and a mixer gel temperature of 242° C. to prepare Ex 24-25 and Comp Ex T. Table 7 below summarizes additional composition and process information as well as test results.

TABLE 7

| | Cell | | | | | | | | | | Longevity |
|---|---|---|---|---|---|---|---|---|---|---|---|
| | Size, | PE2 | PPA1 | PS1 | TE1 | FR4 | CB2 | CB3 | CB4 | Density | (Days |
| ID | (mm) | (wt %) | (wt %) | (wt %) | (wt %) | (wt %) | (wt %) | (wt %) | (wt %) | (kg/m³) | @150° C.) |
| Ex 24 | 0.65 | 10 | 0.8 | 0.2 | 0.6 | 0.5 | 7 | 0 | 0 | 14.4 | 28 |
| Ex 25 | 0.7 | 10 | 0.8 | 0.2 | 0.6 | 0.6 | 4 | 3 | 0 | 13.8 | 27 |
| Comp Ex T | 0.35 | 10 | 0.8 | 0.2 | 0.6 | 0.6 | 4 | 0 | 3 | 15.6 | 17 |

The data presented in Table 7 show that furnace black can be added to carbon black without adversely affecting foam longevity whereas adding graphite does adversely affect foam longevity. In addition, graphite appears to induce cell nucleation, thereby resulting in a smaller cell size which may also be undesirable.

### EX 26 AND COMP EX U

Use Process #1 to prepare Ex 26-28 and Process #2 to prepare Comp Ex U. Ex 26-28 contain 10 wt % PE1 and Comp Ex U contains 20 wt % PE2. As thermal stabilizers, Ex 26 contains 0.6 wt % HALS1, Comp Ex U contains 0.35 wt % NOR1 and 1 wt % TE1, Ex 27 contains 0.2 wt % NOR2 and Ex 28 contains 0.4 wt % NOR2. Table 8 below contains additional composition and process information as well as test results.

TABLE 8

| | | Mixer | | | | | | | | | |
|---|---|---|---|---|---|---|---|---|---|---|---|
| | | Gel | | | | | | | Cell | | Longevity |
| | PP | Temp | PPA1 | PPA2 | PS1 | FR1 | CB1 | CB2 | Size, | Density | (Days |
| ID | Type | (° C.) | (wt %) | (wt %) | (wt %) | (wt %) | (wt %) | (wt %) | (mm) | (kg/m³) | @150° C.) |
| Ex 26 | Blend 1 | 200 | 0.8 | 0.2 | 0.2 | 0.35 | 5 | 0 | 0.75 | 17.2 | 38 |
| Comp Ex U | PP1 | 214 | 0.8 | 0.2 | 0.2 | 0 | 5 | 0 | 0.35 | 14.0 | 38 |
| Ex 27 | Blend 1 | 198 | 0.4 | 0 | 0.2 | 0.35 | 5 | 0 | 0.68 | 15.1 | 42 |
| Ex 28 | Blend 1 | 197 | 0.4 | 0 | 0.2 | 0.35 | 5 | 0 | 0.81 | 14.9 | 48 |

The data presented in Table 8 show the utility of thermal stabilizers other than thioethers. Ex 26 shows that aromatic bromine compounds are compatible with HALS thermal stabilizers. Although Comp Ex U contains no bromine compounds as flame retardant additives, data extrapolation from Tables 3-7 suggest that adding flame retardant additives, such as the type and amount added to Ex 26, would not degrade foam longevity below 25 days. In other words, adding 0.35 wt % FR1 to Comp Ex U should convert it to an example of the present invention.

### EX 29-32

Use Process #2 and Blend 3 and FR1 to prepare Ex 29-31. Use Process #2 and Blend 5 and FR6 to prepare Ex 30-32. Ex 29 and Ex 31 contain respectively 0.75 wt % and 2.5% antimony oxide (TRUTINT™ A03, Great Lakes Chemical Corporation) and Ex 30 and Ex 32 contain 0.5 wt % poly-1,4-isopropylbenzene, both of which are conventional flame retardant synergists. Table 9 shows process information and test results.

TABLE 9

| | Mixer | | | | | | | | | | |
|---|---|---|---|---|---|---|---|---|---|---|---|
| | Gel | | | | | | FR | | Cell | | Longevity |
| | Temp | PPA1 | PS1 | PPA2 | TE1 | PE2 | Level | CB1 | Size | Density, | (Days |
| ID | (° C.) | (wt %) | (wt %) | (wt %) | (wt %) | (wt %) | (wt %) | (wt %) | (mm) | (kg/m³) | @150° C.) |
| Ex 29 | 232 | 0.8 | 0.2 | 0.1 | 0.6 | 10 | 1.5 | 5 | 1.1 | 16.1 | 33 |
| Ex 30 | 225 | 0.8 | 0.2 | 0.1 | 0.6 | 10 | 1.5 | 5 | 0.6 | 20.2 | 31 |
| Ex 31 | 216 | 0.8 | 0.2 | 0.1 | 0.6 | 12 | 5.0 | 5 | 0.6 | 14.4 | 28 |
| Ex 32 | 216 | 0.8 | 0.2 | 0.1 | 0.6 | 12 | 5.0 | 5 | 1.3 | 15.5 | 35 |

The data presented in Table 9 show that addition of traditional FR synergists do not adversely affect foam longevity. In addition to the data presented in Table 9, the foams of Ex 29 and 30 also pass flammability testing with a B2 rating.

### EX 33-34 AND COMP EX V-W

### Effect of FSD Treatment of Carbon Black

Use Process #1, Blend 1, varying amounts of PE1 (in wt % based on total polymer content), 0.35 parts per hundred parts polymer (pph) of FR1, 0.8 wt % PPA1, 0.2 wt % PS1 and the remaining ingredients shown in Table 10 to prepare Ex 33-34 and Comp Ex V-W. Subject Ex 33-34 and Comp Ex V-W to testing as described above. Table (10) also summarizes test results.

For Comp Ex V and Ex 33, pre-compound FSD1 at 1.25 wt % with CB1 at 11 wt % into PE1 using a 30 mm Warner Pfleiderer twin screw compounder. For Comp Ex W and Ex 34, surface treat CB1 with a dilute solution of FSD2 (a viscous liquid) at a loading of 5 percent by weight of FSD2, based on weight of CB1, the FSD2 being diluted with 130 milliliters of methyl chloride (CH₂Cl₂) using the following three-step method: In step one, wet PE2 pellets with the dilute solution of FSD2 using a 20 liter (L) Papenmeyer (rapid powder mixer). In step two, add CB1 powder to the mixer to provide a ternary mixture and mix the ternary mixture using the highest speed setting on the Papenmeyer mixer. In step three, use a Buss Kneader to simultaneously devolatilize and extrusion compound the ternary mixture into pellets.

TABLE 10

| | Mixer | | | | | | | | | |
|---|---|---|---|---|---|---|---|---|---|---|
| | Gel | | | | | | | Cell | | Longevity |
| | Temp | CB1 | CB2 | TE1 | PE1 | FSD1 | FSD2 | Size | Density | (Days |
| ID | (° C.) | (wt %) | (wt %) | (wt %) | (wt %) | (wt %) | (wt % | (mm) | (kg/m³) | @150° C.) |
| Comp | 241 | 4 | 0 | 0 | 31 | 1 | 0 | 0.45 | 14.7 | 45 |
| Ex V | | | | | | | | | | |
| Ex 33 | 239 | 4 | 0 | 0.6 | 30 | 0.5 | 0 | 0.45 | 15.4 | 53 |
| Comp | 239 | 0 | 4 | 0 | 16 | 0 | 0.2 | 0.93 | 15.5 | 45 |
| Ex W | | | | | | | | | | |
| Ex 34 | 233 | 0 | 4 | 0.6 | 31 | 0 | 0.2 | 0.65 | 15.1 | 48 |

The data in Table 10 show that the use of an FSD improves longevity.

### EX 35 AND COMP EX X

### Effect of Contact with Uncured Concrete Upon Foam Longevity

Use Process #2 and Blend 6 to prepare Ex 35 and Comp Ex X. Ex 35 and Comp Ex X both contain 12 wt % PE1, 0.8 wt % PPA1, 0.2 wt % IRGANOX B225, commercially available from Ciba Specialty Chemicals, 0.6 wt % FR1 and 7 wt % CB1. Table 11 below contains additional composition information as well as foam properties and results of longevity testing (in terms of days at 150° C.) after the foams of Ex 35 and Comp Ex X are placed in contact with wet concrete according to the modified procedure described above.

TABLE 11

| | Mixer | | | | | |
|---|---|---|---|---|---|---|
| | Gel | | | Cell | | Longevity |
| | Temp | TE1 | HALS 1 | Size | Density | (Days |
| ID | (° C.) | (wt %) | (wt %) | (mm) | (kg/m³) | @150° C.) |
| Ex 35 | 218 | 0 | 0.4 | 1.1 | 18.3 | 36 |
| Comp | 218 | 0.6 | 0 | 1.25 | 17.7 | 27 |
| Ex X | | | | | | |

The data presented in Table 11 show that incorporation of a HALS into a propylene polymer foam improves longevity test results for the foam. Similar results are expected with other stabilizing additives, particularly NOR1 and NOR2.

1. A propylene polymer foam consists essentially of:
a. a polymer resin composition having a propylene moiety content of at least 50 percent by weight, based upon composition weight;
b. an amount of infrared radiation blocking material sufficient to provide the foam with a thermal conductivity that is at least 0.0005 Watts per meter-kelvin less than the thermal conductivity of a propylene polymer foam comprising only a., c., d., and e., the infrared radiation blocking material being selected from the group consisting of carbon black, activated carbon black, graphite and mixtures thereof;
c. at least one bromine compound, the bromine compound being present in an amount sufficient to provide the foam with DIN 4102 flammability rating of B2;
d. a phenolic-based antioxidant; and
e. at least one stabilizing additive selected from hindered amine light stabilizers, N-alkoxy amine stabilizers, N-hydroxyl amine stabilizers and thiosynergists, the stabilizing additive(s) being substantially non-reactive with the bromine compound and present in an amount sufficient to provide the foam with a resistance to thermal aging, at a temperature of 150° C., that is both (1) at least 25 days in duration and (2) 3 days longer than the resistance to thermal aging of a foam comprising only a., b., c., and d.

2. The foam of claim 1, wherein the foam further comprises an amount of f., f. being a filler surface deactivator, the amount being sufficient to offset potential adverse effects of b., the filler surface deactivator being an epoxy resin or an epoxy compound.

3. The foam of claim 1, wherein the bromine compound is an aromatic bromine compound selected from the group consisting of decabromodiphenyl ethane, a di-2-ethylhexyl ester of tetrabromophthalate, octabromodiphenyl oxide, bis(tribromophenoxy)ethane, tris(tribromoneopentyl)phosphate, brominated trimethylphenyl indane, and brominated epoxy resins, the bromine compound being present in an amount sufficient to provide a bromine content of at least 0.2 weight percent, based on polymer resin composition weight.

4. The foam of claim 1, wherein the foam has a density of less than 24 kilograms per cubic meter

5. The foam of claim 1, wherein the foam has an average cell size within a range of from 0.1 millimeter to 1.5 millimeter.

6. The foam of claim 1, wherein the foam is a plank that has a coalesced strand structure, the plank having a thickness within a range of from 10 mm to 100 mm.

7. The foam of claim 1, wherein the infrared radiation blocking material is a low structure carbon black selected from the group consisting of thermal black, furnace black, acetylene black and channel black, the carbon black having an average particle size within a range of from 10 nm to 400 nm and being present in an amount of at least 2 percent by weight, based on polymer resin composition weight.

8. The foam of claim 1, wherein the foam has a thermal conductivity of no more than 0.045 Watts per meter-kelvin.

9. The foam of claim 1, wherein the infrared radiation blocking material is graphite, the graphite having an average particle diameter of from 1 to 200 micrometers and being present in an amount within a range of from 0.1 to 10 weight percent, based on polymer resin composition weight.

10. The foam of claim 1, wherein the phenolic-based antioxidant is present in an amount of at least 0.2 weight percent, based on polymer resin composition weight.

11. A thermal insulation structure suitable for use as insulation between wall studs in wood frame construction, insulation between rafters or ceiling joists, or as the insulation component within an insulated concrete wall panel or an interior cavity of a brick and concrete block wall or a poured concrete wall, the structure comprising the foam of claim 1.

12. A thermal insulation combination, the combination comprising the foam of claim 1 and a building or structure space selected from gaps between adjacent building wall studs, gaps between adjacent rafters, gaps between adjacent ceiling joists, gaps between inner and outer panel segments of an insulated concrete wall panel, interior cavities of a brick and concrete block wall or interior cavities of a poured concrete wall.
